(19) United States
(12) Patent Application Publication
(10) Pub. No.: US 2023/0381561 A1
(43) Pub. Date: Nov. 30, 2023

(54) COOLING SYSTEM WITH FIRE SUPPRESSION CAPABILITIES

(71) Applicant: Eaton Intelligent Power Limited, Dublin 4 (IE)

(72) Inventor: Christopher T. CANTRELL, Jackson, MI (US)

(21) Appl. No.: 18/325,803

(22) Filed: May 30, 2023

Related U.S. Application Data
(60) Provisional application No. 63/347,374, filed on May 31, 2022.

(51) Int. Cl. A62C 3/08; A62C 37/36; A62C 35/13

(52) U.S. Cl. CPC A62C 3/08; A62C 37/36; A62C 35/13; B64D 2045/009

(57) ABSTRACT

A system for fire suppression in an aircraft includes hot and cold coolant lines, a heat exchanger separately coupled to the hot coolant lines and to the cold coolant lines, and spray outlets along the coolant lines. Smoke or fire detectors are disposed at multiple locations of the aircraft. In certain examples, the coolant lines having supercritical carbon dioxide (SCO₂) circulating therein. Regulating valves are coupled to the spray outlets to control flow of the SCO₂ through the spray outlets. A controller manages activation of the regulating valves to spray SCO₂ through the spray outlets.

### CROSS-REFERENCE TO RELATED APPLICATION

This application claims the benefit of provisional application Ser. No. 63/347,374, filed May 31, 2022, which is incorporated herein by reference in its entirety.

### BACKGROUND

Various components within an aircraft require thermal management to operate. For example, a propeller motor and a battery powering the propeller motor both generate heat during operation and can overheat (surpass an upper temperature limit) if left uncooled. Overheating may lead to electrical fires. Certain components, such as the battery, also may have a lower temperature limit to operate properly. Accordingly, the aircraft is equipped with a thermal management system including cooling circuits for these components.

### SUMMARY

An aircraft (e.g., an electric aircraft) includes one or more components (e.g., electrical components) that generate heat during operation. Uncooled components can overheat leading to malfunction and/or fire. The aircraft includes an onboard thermal management system including cooling lines to provide cooling to various components. For example, cooling of components of an aircraft may include power electronics cooling, propulsive motor cooling, battery cooling, and/or fuel cell cooling.

In accordance with some aspects of the disclosure, the onboard cooling system can provide a dual function of both cooling the various components and providing fire suppression at one or more of the various components. By incorporating spray outlets along the cooling lines of the onboard cooling system, coolant from the cooling system can be directed towards a fire starting at various locations along the cooling system. Regulating valves are disposed at the spray outlets to control whether at least some coolant passes through the spray outlet or remains in the cooling lines to complete a cooling circuit.

In certain implementations, actuation of the regulating valves is managed based on feedback from one or more smoke or fire detectors. The smoke or fire detectors can be positioned throughout the aircraft. In certain examples, the smoke or fire detectors may be positioned in proximity to one or more heat-generating components within the aircraft. In certain examples, the actuation of the regulation valves is based on the signals received from the nearest or one of the nearest smoke or fire detectors.

In certain implementations, the coolant includes carbon dioxide. In certain examples, the coolant includes supercritical carbon dioxide (SCO₂). SCO₂ is a fluid state of carbon dioxide that looks like a gas but behaves like a liquid. SCO₂ is efficient in terms of basic thermodynamic cycle, and is more environmentally sustainable due to low carbon emissions. SCO₂ also is useful in fire suppression. Accordingly, SCO₂ may be provided as the cooling media in an existing cooling system, and the cooling media may also be used as a fire suppressant when delivered to areas experiencing an electric fire. In certain implementations, the cooling system includes a reservoir with a sufficient amount of SCO₂ to both ensure cooling of the system and fire suppression.

In one aspect, the technology relates to a fire suppressing system in an aircraft. For example, the fire suppressing system includes a plurality of coolant lines having SCO₂ circulating therein and including hot coolant lines and cold coolant lines, a heat exchanger separately coupled to the hot coolant lines and to the cold coolant lines, a plurality of spray outlets along the plurality of coolant lines, and a plurality of smoke or fire detectors disposed in a plurality of locations of the aircraft.

In an example of the above aspect, the system further includes a plurality of regulating valves, each regulating valve can be coupled to one of the spray outlets and be configured to control flow of the SCO₂ through the spray outlets.

In another example, the system further includes a controller coupled to the plurality of smoke or fire detectors and to the regulating valves. The controller can be configured to activate one or more of the regulating valves to spray SCO₂ through one or more of the spray outlets coupled to the one or more regulating valves. In an example, the controller is configured to activate the one or more regulating valves when one or more of the smoke or fire detectors closest to the one or more regulating valves detect an occurrence of smoke or fire.

In another example, the system further includes a reservoir of SCO₂. The reservoir may have a size that is large enough to include a sufficient amount of SCO₂ for cooling and for fire suppression.

In yet another example, each of the spray outlets can include a spray nozzle. In another example, the aircraft is an electric aircraft.

In another aspect, the technology relates to a fire suppressing system in an aircraft. The fire suppressing system may include a plurality of coolant lines. The coolant lines may have SCO₂ circulating therein and include hot coolant lines and cold coolant lines. The fire suppressing system may also include a heat exchanger coupled to the hot coolant lines and to the cold coolant lines. A plurality of spray outlets may be positioned along the plurality of coolant lines and a plurality of smoke or fire detectors may be disposed in a plurality of locations on the aircraft. A processor may be operatively coupled to the smoke or fire detectors and to the spray outlets and a memory may be coupled to the processor. The memory may store instructions that, when executed by the processor, perform a set of operations. In various examples, the set of operations include monitoring the plurality of smoke or fire detectors for an occurrence of elevated temperature, voltage, fire or smoke, and determining, via one or more of the smoke or fire detectors, whether a fire or smoke has occurred in the aircraft. When the occurrence of fire or smoke is detected, the method includes identifying, via the processor, one or more of the smoke or fire detectors that detected the occurrence of fire or smoke, and activating, via the processor, one or more of the plurality of spray outlets that are closest to the one or more of the smoke or fire detectors to spray SCO₂ on the detected smoke or fire.

In an example of the above aspect, the system further includes a reservoir of supercritical CO₂. The reservoir includes one or more SCO₂ level sensors. The set of instructions further includes monitoring, via the processor coupled to the one or more level sensors, a level of SCO₂ inside the reservoir, and interrupting the activation of the spray outlets when the level of SCO₂ inside the reservoir reaches a threshold level. In an example, the threshold level corresponds to an amount of SCO₂ that is necessary to continue operation of the aircraft. In yet another example, the system further includes a plurality of regulating valves, each regulating valve being coupled to one of the plurality of spray outlets, and the set of instructions includes activating one or more of the plurality of spray outlets by controlling an operation of a regulating valve coupled to each of the one or more spray outlets. In another example, the aircraft is an electric aircraft.

In another aspect, the technology relates to a modular fire suppression system including a pump, a reservoir configured to hold SCO₂, a plurality of coolant lines including hot coolant lines and cold coolant lines, a heat exchanger configured to be coupled to the coolant lines, the pump, and the reservoir. For example, the coolant lines and the heat exchanger are housed in a housing that is configured to be coupled to an existing heat source. In an example, the existing heat source can be a battery system, power electronics, or a propulsive motor. In another example, the existing heat source can be an aircraft battery system, an aircraft power electronics, and an aircraft propulsive motor. In a further example, the aircraft is an electric aircraft.

In yet another aspect, the technology relates to a method of fire suppression in an aircraft. For example, the method includes monitoring a plurality of fire or smoke detectors in the aircraft, determining whether a fire or smoke has occurred in the aircraft, and identifying the smoke or fire detectors that detected the occurrence of fire or smoke. In an example, when the occurrence of fire or smoke is detected, the method includes identifying spray outlets that are closest to the identified smoke or fire detectors, and activating the identified spray outlets to spray supercritical CO₂ on the detected smoke or fire.

In an example, the method further includes monitoring a level of SCO₂ inside a reservoir feeding the spray outlets, and interrupting the activation of the spray outlets when the level of SCO₂ inside the reservoir reaches a threshold level. In another example, the threshold level corresponds to an amount of SCO₂ that is necessary to continue operation of the aircraft. In yet another example, the method further includes activating one or more of the plurality of spray outlets by controlling an operation of one or more regulating valves coupled to each of the one or more spray outlets.

### BRIEF DESCRIPTION OF THE DRAWINGS

The accompanying drawings, which are incorporated in and constitute a part of the description, illustrate several principles of the present disclosure. A brief description of the drawings is as follows:

FIG. 1 is a diagram of a cooling circuit for an electrical component, for example, a motor and motor controller.

FIG. 2 illustrates a cooling system configured in accordance with principles of the disclosure.

FIG. 3 is a diagram of a cooling circuit for an aircraft, in accordance with principles of the disclosure.

FIG. 4 illustrates an example fire suppressing spray nozzle configured in accordance with principles of the disclosure.

FIG. 5 is a flow chart illustrating a method of using an aircraft cooling system for fire suppression in accordance with principles of the disclosure.

FIG. 6 depicts a block diagram of a computing device in accordance with the principles of the present disclosure.

FIG. 7 is an illustration of a modular cooling and fire suppression system, in accordance with various principles of the present disclosure.

### DETAILED DESCRIPTION

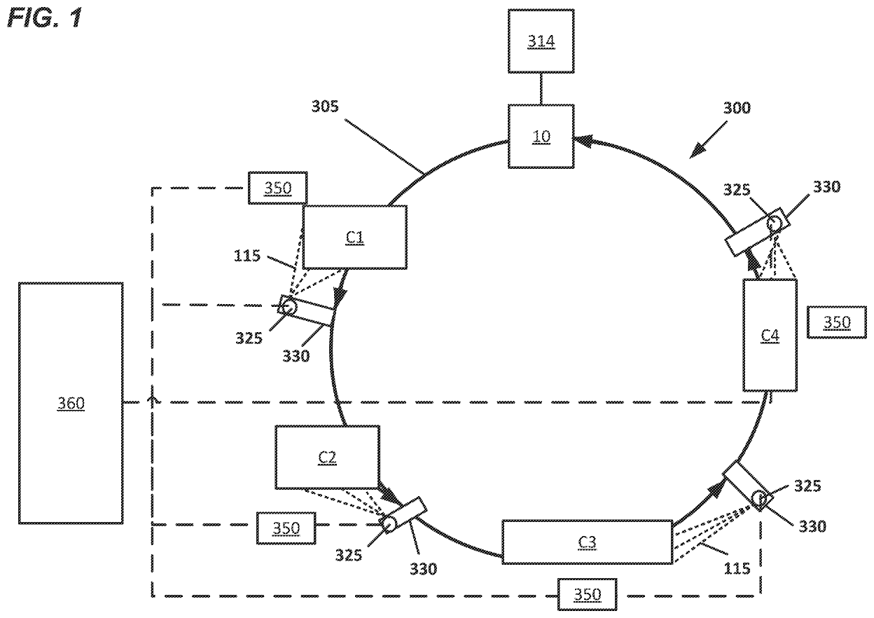

Referring to FIG. 1, an onboard cooling system 300 of an aircraft can provide a dual function of both cooling the various components C1-C4 and providing fire suppression at one or more of the various components C1-C4. By incorporating spray outlets 330 along the cooling lines 305 of the onboard cooling system 300, coolant 115 from the cooling system 300 can be directed towards a fire starting at various locations along the cooling system 300. In certain implementations, at least some of the locations may correspond with one or more of the components C1-C4 being cooled. Valves 325 are disposed at the outlets 330 to control whether at least some coolant 115 passes through each outlet 350 or remains in the cooling lines 105 to progress along the cooling circuit.

In certain implementations, actuation of the valves 325 is managed based on feedback from one or more smoke or fire detectors 350. The smoke or fire detectors 350 (e.g., optical detectors, temperature detectors, gas detector, current detector) can be positioned throughout the aircraft. In some implementations, the detectors 350 can directly sense the flame or the smoke of a fire. In other implementations, the detectors 350 can sense a condition that implies a fire or imminent fire (e.g., by sensing an accelerating current level of an electrical component). In certain examples, the smoke or fire detectors 350 may be positioned in proximity to one or more heat-generating components C1-C4 within the aircraft. In certain examples, the actuation of the valves 325 is based on the signals received from the nearest or one of the nearest smoke or fire detectors 350. In certain implementations, a controller 360 receives the signals from the smoke or fire detectors 350, processes the signals to determine the presence or imminent presence of a fire, determines which outlet 330 should dispense coolant 115, and opens the valve 325 for the selected outlet 330.

Examples of the present disclosure also include a reservoir 14 of coolant that includes a sufficient amount of coolant for ordinary cooling of the aircraft, and for spraying a sufficient amount of coolant onto a fire to extinguish the fire. In certain implementations, the coolant includes carbon dioxide. In certain examples, the coolant includes supercritical carbon dioxide (SCO₂). SCO₂ is a fluid state of carbon dioxide that looks like a gas but behaves like a liquid. SCO₂ is efficient in terms of basic thermodynamic cycle, and is more environmentally sustainable due to low carbon emissions. SCO₂ also is useful in fire suppression. Accordingly, SCO₂ may be provided as the cooling media in an existing cooling system, and the cooling media may also be used as a fire suppressant when delivered to areas experiencing an electric fire. In certain implementations, the cooling system includes a reservoir with a sufficient amount of SCO₂ to both ensure cooling of the system and fire suppression.

SCO₂ is a fluid state of carbon dioxide (CO₂) where the CO₂ is heated and held at or above its critical temperature and pressure. In the supercritical phase, CO₂ exhibits properties and behaviors between those of a liquid and a gas. In particular, supercritical CO₂ possesses liquid-like densities with gas-like diffusivity, surface tension and viscosity. When CO₂ exceeds temperatures of 87.9° F. (31.1° C.) and is subjected to pressures above 1071 psi (7.39 MPa), CO₂ enters the supercritical phase. This supercritical phase of CO₂ is commonly used as a solvent in chemical extraction processes due to its high solubility, low toxicity and minimal net effect on the environment. In this case, SCO₂ may be used as a coolant and/or a fire suppressant. When released to suppress fire, SCO₂ evaporates and becomes CO₂ gas. Carbon dioxide provides the advantage of being environmentally preferred to other fire suppressants, and can result in higher efficiencies than typical refrigeration systems such as, e.g., propylene glycol and water-based systems.

Examples of the present disclosure include a cooling system having a plurality of valves 325 (e.g., regulating valves, on/off valves, etc.) and a plurality of outlets 330 (e.g., spray ports, nozzles, etc.) along the coolant lines 305, the outlets 330 and valves 325 can be configured so that upon sensing that an electric fire has started, e.g., by a smoke or fire detector 350, the valves 325 and the outlets 330 are actuated to spray coolant onto the electrical fire.

Other examples of the disclosure include adding one or more outlets 330 to a conventional cooling system 100 to enable the secondary purpose of fire suppression without the additional cost and weight of adding a separate secondary system. For example, outlets 330 may be provided along existing coolant lines 105 (e.g., cold coolant lines 120 or hot coolant lines 110) in locations where electric fire may potentially occur. In examples, the spray ports may be integrated into the existing coolant lines via, e.g., a threaded connection (e.g., a “Tee,” or other technique), so as to be able to direct the coolant media, which is flowing through the coolant lines 105, out of the coolant lines 105 and towards, e.g., a fire occurring in the vicinity thereof. Example outlets 330 include nozzles or other structures configured to spray or otherwise direct fluid flow. In addition, valves 325 (e.g., regulating valves) may be placed along the existing coolant lines 105 to allow the spray of coolant to take place. In some examples, the valves 325 are automatically or electrically actuated based on a control signal from the controller 360. In other examples, the valves 325 can be mechanically actuated based on, e.g., a thermocouple response.

In various examples, the sizing of the coolant/fire suppression system 300, e.g., the sizing of the reservoir 14 that holds the coolant, may be such that the system 300 is able to provide a sufficient amount of coolant to suppress the fire while still retaining a sufficient amount of coolant to continue cooling the aircraft system (e.g., the electrical components C1-C4) for a sufficient amount of time to land the aircraft or otherwise refill the coolant system. For example, a coolant reservoir 14 may be added to the existing cooling system. In certain examples, the coolant reservoir 14 may be sized so as to be able to hold a sufficient amount of coolant to both ensure cooling of the electrical components C1-C4 and, as needed, fire suppression.

For example, the reservoir 14 may include about one (1) to two (2) gallons of additional coolant 115 (e.g., SCO₂) in order to appropriately respond to a fire occurrence. In certain implementations, the one (1) to two (2) gallons are in addition to the amount of coolant 115 needed to ensure cooling of the system (e.g., the electrical components C1-C4) of the aircraft. In certain implementations, the amount of coolant 115 (e.g., SCO₂) that may be necessary to ensure cooling of the system may be, e.g., two (2) to four (4) gallons. Accordingly, about 25-50% of the coolant 115 that is stored in the reservoir 15 may be dedicated to suppressing a fire. As another example, if long duration equipment cooling is not required in the aircraft, then the amount of coolant 115 that is carried on board may be reduced to more closely match the needs for fire suppression without reserves for continuing to cool components C1-C4.

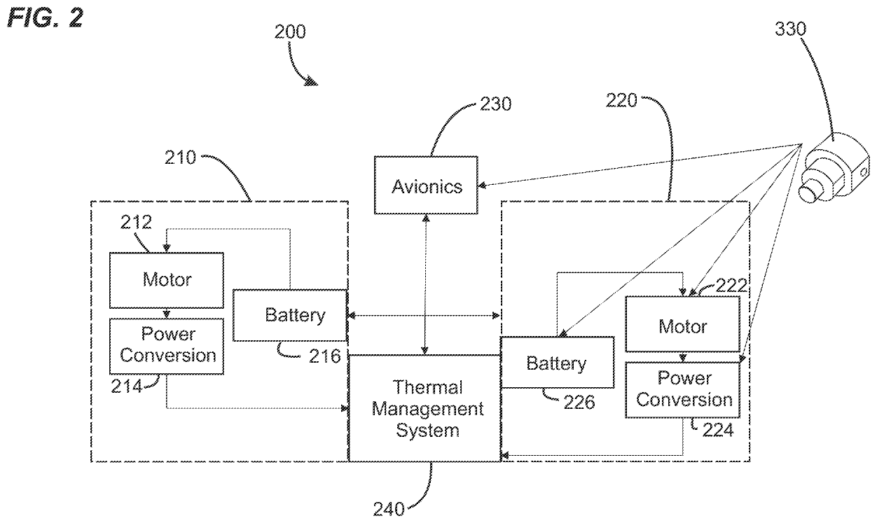

FIG. 2 is a diagram illustrating an example heat generating systems on board an aircraft system 200. A thermal management system 240 implementing the cooling system 300 of FIG. 1, is configured to cool various heat generating components on board the aircraft system 200. For example, in FIG. 2, the aircraft system 200 includes one or more first heat generating arrangements 210 along a first wing of the aircraft and one or more second heat generating arrangements 220 along a second wing of the aircraft. In certain examples, each heat generating arrangement 210, 220 may include a motor 212, 222, a power conversion module 214, 224, and/or a battery 216, 226. In certain implementations, the aircraft system 200 also includes various avionic equipment 230.

In various examples, portions of the coolant lines 105 in the vicinity of each of the heat-generating components (e.g., the battery 216, 226, the motor 212, 222 and the power conversion module 214, 224) include, or are coupled to, one or more spray nozzles 150 configured to release coolant (e.g., SCO₂) on a fire occurring next to a selected one of the battery 216, 226, the motor 212, 222 and/or the power conversion module 214, 224. In various examples, in the event of a fire, all or part of the avionics 230 also may be sprayed with coolant by one or more of the spray nozzles 150 located closest thereto.

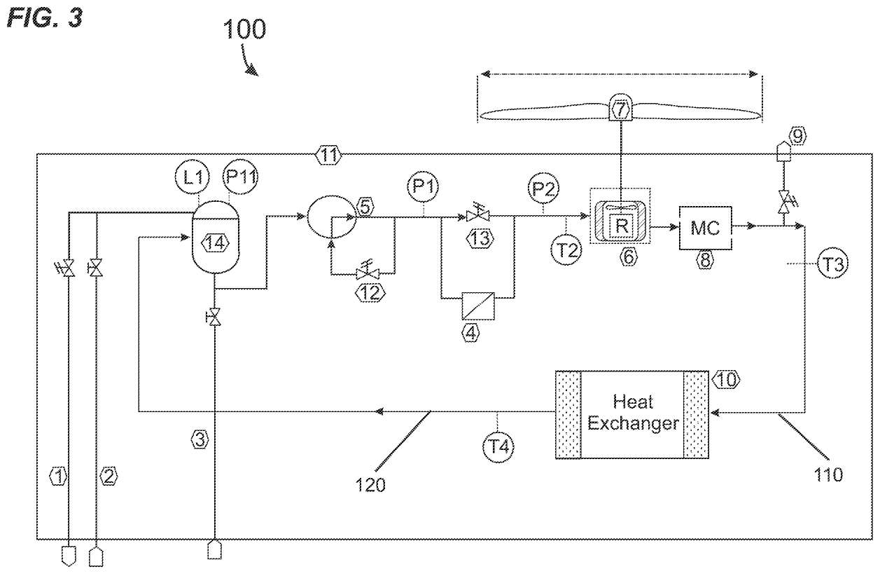

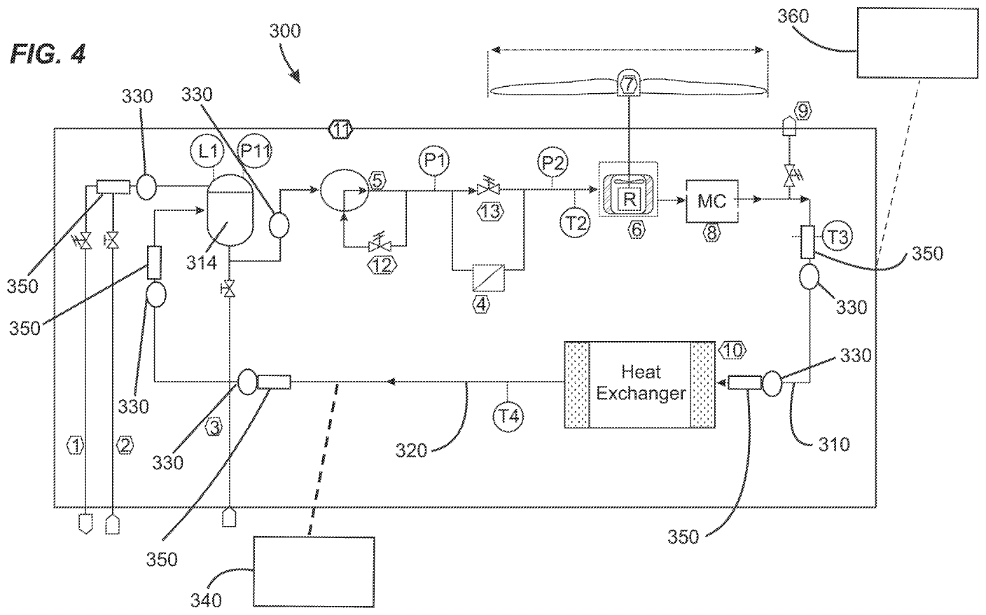

FIGS. 3 and 4 illustrate how a conventional cooling system 100 can be modified to add fire suppression capabilities. FIG. 3 is an overview of an example conventional cooling circuit 100 for a motor and motor controller. For example, the conventional cooling system 100 may use a single-phase PGW (Propylene Glycol Water mix) coolant. Alternatively, the conventional cooling system 100 may use SCO₂ or any other desired coolant. The coolant is held in the reservoir 14. An electric propulsive motor may drive the aircraft. The electric propulsive motor being, e.g., an alternative current (AC) motor that produces heat during an operation thereof. There may also be an inverter configured to convert battery direct current (DC) power to AC power for the motor. The inverter also produces waste heat. The coolant running through the coolant lines 105 (e.g., lines 110 and 120) is pushed by a pump 5 through both of these devices and gathers heat as it flows through the electric propulsive motor and the inverter. The hot coolant flowing through hot coolant lines 110 enters a heat exchanger 10, in which it travels through a series of channels designed to expel that waste heat as cool air travels through a series of air-passageways. The heat exchanger 10 removes heat from the coolant so that cooled coolant 115 exits the heat exchanger 10 and this cycle is repeated. A more detailed description of operation is provided below.

Further in FIG. 3, the conventional cooling system 100 includes the heat exchanger 10 coupled to both hot coolant lines 110 and cold coolant lines 120. The cold coolant lines 120 connect the heat exchanger 10 with the coolant reservoir 14. At the coolant reservoir 14, a reservoir fluid level L1 and a gas charge pressure indicator P11 are disposed. The coolant reservoir 14 is connected to a circuit formed by the pump 5 and a pump bypass valve 12, and then to a circuit including a filter/strainer 4 and a filter bypass valve 13. At the exit of the filter bypass valve 13, a filter outlet pressure P2 and a temperature reader T2 for the coolant temperature are provided to measure the temperature and the pressure of the coolant. An electromotive assembly 6, connected to the main rotor 7, which are heat generating devices and are to be cooled by the cold coolant lines 120, are provided at an outset of the filter outlet pressure P2 and a temperature reader T2. The cold coolant lines 120 extend from the heat exchanger 10 to the electromotive assembly 6.

Following contact with the electromotive assembly 6, the coolant, now hot and part of the hot coolant lines 110, flows through a motor drive 8. Occasionally, a coolant bleed/relief valve may reduce temperature or pressure of the coolant inside the hot coolant lines 110. A coolant temperature outlet T3 monitors the temperature of the coolant inside the hot coolant lines 110. The hot coolant lines 110 flow the hot coolant into the heat exchanger 10 where the coolant is cooled and becomes part of the cold coolant lines 120. In the conventional cooling system 100, cooling is ensured by the coolant mix. However, the coolant mix is not a particularly efficient fire suppressant.

FIG. 4 is an overview of a cooling circuit for an aircraft, in accordance with various principles of the present disclosure. The cooling circuit 300 of FIG. 4 is similar to the conventional cooling system 100 discussed above, but includes a number of additional features. The coolant lines 305 (e.g., hot coolant lines 310 and/or cold coolant lines 320) include a plurality of outlets 330 (e.g., spray nozzles) located at various locations along the coolant lines 305. For example, the various locations may be determined based on a most efficient configuration, based on locations where a fire is more likely to occur, based on the locations of any previous fires, or based on other considerations such as available space, cost, and the like. In various examples of the cooling circuit 300, the coolant lines 305 are configured to carry SCO₂ as the coolant 115.

In various examples of the disclosure, substituting SCO₂ for PGW can be performed without major retooling of the cooling circuit because, unlike cryogenics or liquid nitrogen, SCO₂ systems typically does not require extensive machine-tool modifications. Instead, SCO₂ can be integrated with new or existing cooling systems through specific minimal changes to the systems. The SCO₂ may even be harvested CO₂ obtained from recycled sources to reduce the carbon footprint of the cooling circuit 300. In addition, using SCO₂ may result in little coolant waste because the CO₂ gas evaporates while PGW or similar coolant can require costly disposal treatments and the use of chemicals that may be harmful to the environment.

In various examples, the cold coolant lines 320 connect the heat exchanger 10 with a coolant reservoir 314. At the coolant reservoir 314, a reservoir fluid level L1 and a gas charge pressure indicator P11 may be disposed. In various examples, the reservoir 314 includes amounts of coolant that are sufficient to both ensure adequate cooling of the system 300, but also to ensure sufficient fire extinguishing capabilities by being able to spray a sufficient amount of coolant on a fire that may occur in the aircraft while maintaining a sufficient amount of coolant to continue at least a limited operation of the aircraft. Accordingly, the reservoir 314 may be larger than the reservoir 14 discussed above with reference to FIG. 3.

In various examples of the disclosure, the coolant reservoir 314 is connected to a circuit formed by the pump 5 and a pump bypass valve 12, and then to a circuit including a filter/strainer 4 and the filter bypass valve 13. At the exit of the filter bypass valve 13, a filter outlet pressure P2 and a temperature reader T2 for the coolant temperature are disposed to measure the temperature and the pressure of the coolant coolant. The electromotive assembly 6, connected to a main rotor 7, which are to be cooled by the cold coolant lines 120, are disposed following the filter outlet pressure P2 and a temperature reader T2. The cold coolant lines 120 extend from the heat exchanger 10 to the electromotive assembly 6.

Following contact with the electromotive assembly 6, the coolant flows through the motor drive 8, and occasionally a coolant bleed/relief valve may reduce temperature or pressure of the coolant inside the hot coolant lines 310. A coolant temperature outlet T3 monitors the temperature of the coolant inside the hot coolant lines 310. The hot coolant lines 310 flow the hot coolant into the heat exchanger 10 where the coolant is cooled and becomes part of the cold coolant lines 320.

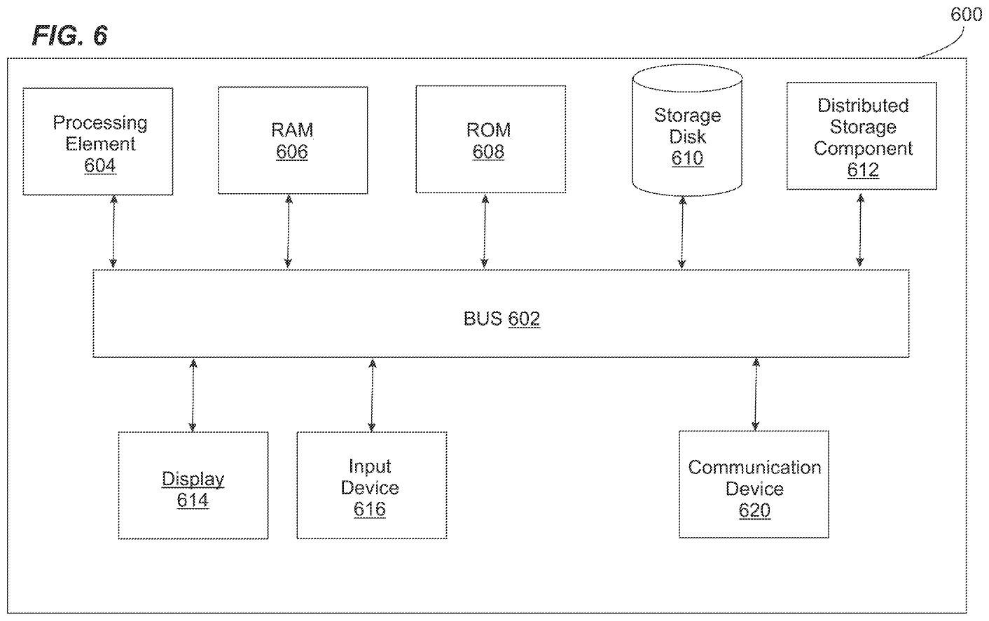

In various examples of the disclosure, the circuit 300 may also include an additional compressor/reservoir 340 coupled to the hot coolant lines 310 and/or the cold coolant lines 320, the compressor/reservoir 340 containing an additional amount of pressurized coolant to ensure, e.g., a sufficient fire extinguishing capability. In other examples, operation of the cooling system 300 and of the outlets 330 may be controlled via a controller 360 coupled to the cooling system 300. For example, the controller 360 may be similar to a processing element 604 discussed below with respect to FIG. 6. In additional examples, one or more fire/smoke detectors 350 may be disposed along the hot coolant line 310 and the cold coolant line 320 in order to detect fires or smoke that may start in various parts of the electric system. For example, the fire/smoke detectors 350 may be located along the respective hot/cold coolant lines 310/320 or in various locations of the aircraft and may be, e.g., next to the outlets 330, or in areas of the electric system that may be susceptible to fires or to smoke.

In accordance with certain aspects of the disclosure, the outlets 330 include spray nozzles configured to direct the coolant towards the fire. In various examples, the spray nozzle constitutes one or more attachments to a coolant line such as, e.g., the hot coolant line 310 or the cold coolant line 320 discussed above with reference to FIG. 3. The attachment causes the coolant (e.g., SCO₂) to be delivered finely and substantially evenly as a spray. The spray nozzles may be used for a plurality of purposes including to distribute the coolant over an area, to increase liquid surface area of the coolant, and/or to create an impact force on a solid surface such as, e.g., a surface being subjected to a fire.

In certain implementations, a spray nozzle includes an outlet port configured to emit coolant to, e.g., extinguish or suppress a fire. In various examples, the spray nozzle may include a plurality of outlet ports. In other examples, the spray nozzle may be or include a plain-orifice nozzle, a shaped-orifice nozzle, a surface-impingement nozzle, a pressure-swirl spray nozzle, a solid-cone nozzle, or a compound nozzle including a plurality of outlets. In yet another example, the spray nozzle may be or include a single-fluid nozzle, the single fluid in this case being or including coolant. In various examples, the spray nozzle may be formed of a material that can withstand the high temperature and pressure necessary to hold coolant therein such as, e.g., temperatures of 87.9° F. (31.1° C.) and pressures above 1071 psi (7.39 MPa). In other examples, the spray nozzle may be similar to the description in U.S. Pat. No. 5,106,659, which is incorporated herein by reference in its entirety.

In various examples, the spray nozzle may have internal passages which transmit the coolant under high pressure from an inlet to the body of the spray nozzle and then to outlet port so that the coolant can be sprayed on, e.g., a fire that may have started. A relatively short flow discharge path within the body may be formed between the internal passages in the spray nozzle and the outlet port in order to avoid the formation of an area of ambient or reduced pressure, so that the coolant may be substantially maintained in solution until it is discharged from the spray nozzle. In other examples, a pressure regulator may be provided to maintain a substantially constant pressure drop across the reservoir (not shown) similar to, e.g., the compressor/reservoir 340 discussed above with respect to FIG. 4. Also, a pressure regulator may be provided between the reservoir and the outlet port of the spray nozzle to induce flow of coolant and to permit a number of spray nozzles to be connected and operational during a fire without creating a substantial pressure drop therebetween, which may reduce or substantially hamper the spray of coolant onto a fire.

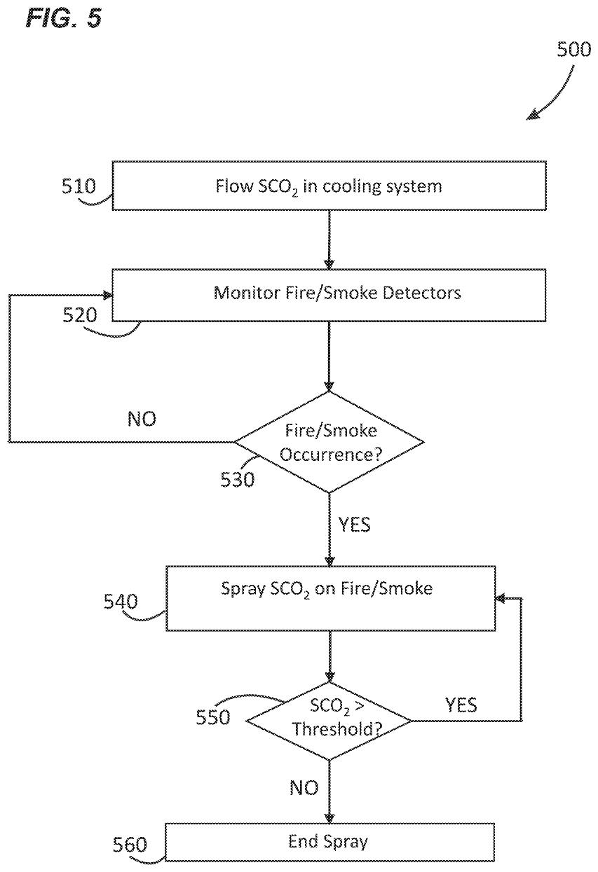

FIG. 5 is a flow chart illustrating a method of using coolant (e.g., SCO₂) as a fire suppressant in an aircraft cooling system, in accordance with various principles of the present disclosure. For the sole purpose of convenience, method 500 is described through use of at least an example computing device 600 below described in combination with the systems discussed above. However, it is appreciated that the method 500 may be performed by any suitable system. In FIG. 5, the method 500 includes operation 510, during which coolant is flowing in a cooling system. For example, the coolant may be SCO₂. In examples, when SCO₂ is used as the cooling medium, the coolant lines such as, e.g., the cold coolant lines 320 discussed above with respect to FIG. 4, may be kept under pressure so as to prevent SCO₂ from transitioning to a gas form and thus become inefficient as a fire suppressant. In various examples, the hot and cold coolant lines may include a plurality of outlets 330 (e.g., at spray nozzles) and the locations of the outlets 330 may be in the vicinity of portions of the electric system or heat generating systems that may be subject to catching fire. In other examples, outlets 330 may be distributed at substantially regular intervals throughout the coolant lines. In various examples, a valve may be present at each outlet (e.g., within each spray nozzle, at an input of each spray nozzle, etc.). The valve may be configured to control the spray of the coolant from the outlet onto a location where a fire has occurred. In other examples, operation of the valve and of the outlet may be controlled by a controller such as, e.g., a remote controller, or a controller similar to controller 360 discussed above with respect to FIG. 4 or computing device 600 discussed below with respect to FIG. 6.

In various examples, during operation 520, smoke/fire detectors distributed at various locations of the electric system are monitored for the occurrence of smoke and/or fire in the electric system or heat generating system. For example, each smoke/fire detector such as, e.g., the smoke/fire detectors 350 discussed above with respect to FIG. 4, may be controlled via a controller such as, e.g., controller 360 discussed above with respect to FIG. 4. During operation 530, if a fire or smoke is detected via, e.g., one or more fire/smoke detectors, then during operation 540, coolant is sprayed on the fire/smoke location. For example, the spray nozzle that is closest to the fire/smoke detector that detected the occurrence of fire or smoke may be activated to spray the coolant thereon. For example, the spray of the coolant may be controlled by a controller such as, e.g., the controller 360 discussed above with respect to FIG. 4. If no smoke/fire is detected during operation 530, then during operation 520, monitoring of the occurrence of fire and/or smoke may continue to be performed.

In various examples, during operation 550, after a fire has been detected during operation 530 and coolant has been sprayed thereon during operation 540, the level of coolant remaining in the reservoir such as, e.g., the reservoir 340 discussed above with respect to FIG. 4, is monitored. In various examples, if the level of coolant remains at or greater than a threshold level, then operation 540 continues to spray coolant as much as necessary to extinguish the smoke or fire that is taking place. In other examples, if, during operation 550, the level of coolant falls below the threshold level, then spraying of coolant may be ended during operation 560. For example, the threshold level may be an amount of coolant that is necessary to maintain cooling of the aircraft or electric aircraft until, e.g., landing of the aircraft. If the level of coolant falls below that threshold level, it may no longer be possible to safely land the aircraft because the electric and other heat generating components of the aircraft may overheat and cause catastrophic failure of the aircraft.

FIG. 6 depicts a block diagram of a computing device, according to various principles of the present disclosure. In certain implementations, the computing device may implement the controller 360 of FIGS. 1 and 4. In the illustrated example, the computing device 600 may include a bus 602 or other communication mechanism of similar function for communicating information, and at least one processing element 604 (collectively referred to as processing element 604) coupled with the bus 602 for processing information. As will be appreciated by those skilled in the art, the processing element 604 may include a plurality of processing elements or cores, which may be packaged as a single processor or in a distributed arrangement. Furthermore, a plurality of virtual processing elements 604 may be included in the computing device 600 to provide the control or management operations for the systems 200 and 300 and to the method 500 illustrated above.

The computing device 600 may also include one or more volatile memory(ies) 606, which can for example include random access memory(ies) (RAM) or other dynamic memory component(s), coupled to one or more busses 602 for use by the at least one processing element 604. Computing device 600 may further include static, non-volatile memory(ies) 608, such as read only memory (ROM) or other static memory components, coupled to busses 602 for storing information and instructions for use by the at least one processing element 604. A storage component 610, such as a storage disk or storage memory, may be provided for storing information and instructions for use by the at least one processing element 604. As will be appreciated, the computing device 600 may include a distributed storage component 612, such as a networked disk or other storage resource available to the computing device 600.

The computing device 600 may be coupled to one or more displays 614 for displaying information to a user, and to an input device 616 for inputting information or instructions. The computing device 600 may further include an input/output (I/O) component, such as a serial connection, digital connection, network connection, or other input/output component for allowing intercommunication with other computing components and the various components of the systems 200 and 300 and to the method 500 illustrated above.

In various embodiments, computing device 600 can be connected to one or more other computer systems via a network to form a networked system. Such networks can for example include one or more private networks or public networks, such as the Internet. In the networked system, one or more computer systems can store and serve the data to other computer systems. The one or more computer systems that store and serve the data can be referred to as servers or the cloud in a cloud computing scenario. The one or more computer systems can include one or more web servers, for example. The other computer systems that send and receive data to and from the servers or the cloud can be referred to as client or cloud devices, for example. Various operations of the systems 200 and 300 and the method 500 illustrated above may be supported by operation of the distributed computing systems.

The computing device 600 may be operative to control operation of the components of the systems 200 and 300 and the method 500 illustrated above through a communication device such as, e.g., communication device 620, and to handle data provided from the data sources as discussed above with respect to the systems 200 and 300 and to the method 500. In some examples, analysis results are provided by the computing device 600 in response to the at least one processing element 604 executing instructions contained in memory 606 or 608 and performing operations on the received data items. Execution of instructions contained in memory 606 and/or 608 by the at least one processing element 604 can render the systems 200 and 300 and the method 500 operative to perform methods described herein.

The term “computer-readable medium” as used herein refers to any media that participates in providing instructions to the processing element 604 for execution. Such a medium may take many forms, including but not limited to, non-volatile media, volatile media, and transmission media. Non-volatile media includes, for example, optical or magnetic disks, such as disk storage 610. Volatile media includes dynamic memory, such as memory 606. Transmission media includes coaxial cables, copper wire, and fiber optics, including the wires that include bus 602.

Common forms of computer-readable media or computer program products include, for example, a floppy disk, a flexible disk, hard disk, magnetic tape, or any other magnetic medium, a CD-ROM, digital video disc (DVD), a Blu-ray Disc, any other optical medium, a thumb drive, a memory card, a RAM, PROM, and EPROM, a FLASH-EPROM, any other memory chip or cartridge, or any other tangible medium from which a computer can read.

Various forms of computer readable media may be involved in carrying one or more sequences of one or more instructions to the processing element 604 for execution. For example, the instructions may initially be carried on the magnetic disk of a remote computer. The remote computer can load the instructions into its dynamic memory and send the instructions over a telephone line using a modem. A modem local to computing device 600 can receive the data on the telephone line and use an infra-red transmitter to convert the data to an infra-red signal. An infra-red detector coupled to the bus 602 can receive the data carried in the infra-red signal and place the data on the bus 602. The bus 602 carries the data to memory 606, from which the processing element 604 retrieves and executes the instructions. The instructions received by the memory 606 and/or memory 608 may optionally be stored on the storage component 610 either before or after execution by the processing element 604.

In accordance with various embodiments, instructions operative to be executed by a processing element to perform a method are stored on a computer-readable medium. The computer-readable medium can be a device that stores digital information. For example, a computer-readable medium includes a compact disc read-only memory (CD-ROM) as is known in the art for storing software. The computer-readable medium is accessed by a processor suitable for executing instructions configured to be executed.

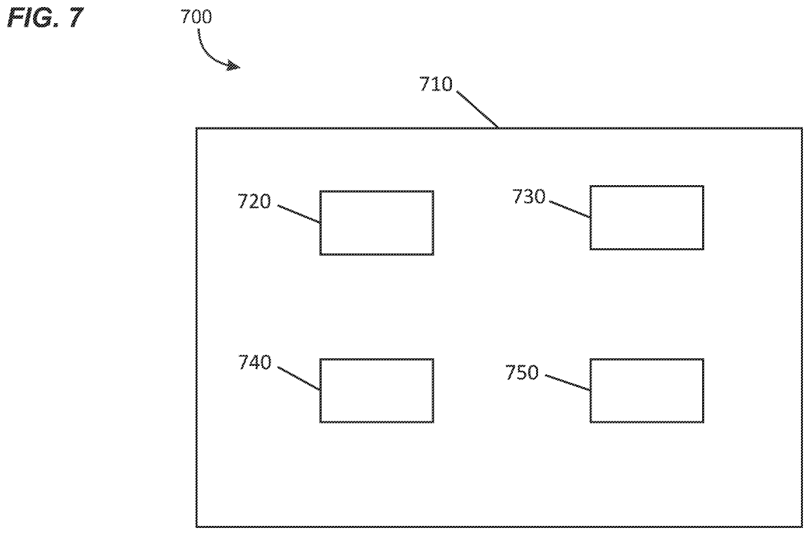

FIG. 7 is an illustration of a modular cooling and fire suppression system, in accordance with various principles of the present disclosure. In various examples, the modular system 700 includes a portable housing 710 such as, e.g., a portable housing 710. In examples, the housing 710 is configured to house a pump 720, a reservoir 730, a plurality of coolant lines 740, and a heat exchanger 750. In examples, the pump 720 can be configured to push coolant (e.g., SCO₂) through the coolant lines 740 arranged at a heat generating component such as, e.g., power electronics, propulsive motor, battery, fuel cells, and the like when the coolant lines 740 are deployed, or through the coolant lines of an existing cooling system of the heat generating component. In various examples, the coolant lines 740 may include spray ports and regulating valves (not shown) along the length thereof. In other examples, both cooling and fire suppression of the heat generating component may be ensured by coolant held in the reservoir 730 and flowed through the deployed coolant lines 740, or flowed through existing coolant lines upon coupling of the housing 710 with the existing cooling system.

In various examples of operation, the modular system 700 may be coupled to the existing heat generating component by deploying the coolant lines 740. The cooling media of the existing system may be replaced by SCO₂ provided by the reservoir 730. In examples, the coolant lines 740 may be deployed along the heat generating component in a traditional configuration for cooling the heat generating component, and SCO₂ may be flowed through the deployed coolant lines 740. As a result, the heat generating component can be properly cooled using SCO₂, the SCO₂ providing the additional capability to extinguish fire due to the existence of spray outlets (not shown), as discussed above with respect to FIG. 5. In other examples, operation of the modular cooling and fire suppression system 700 may be controlled and monitored via a computing device such as, e.g., the computing device 600 discussed above with reference to FIG. 6.

This disclosure described some examples of the present technology with reference to the accompanying drawings, in which only some of the possible examples were shown. Other aspects can, however, be embodied in many different forms and should not be construed as limited to the examples set forth herein. For example, while its been described with reference to an electrical aircraft and, more particularly, to an onboard cooling system for an electric propulsive motor and avionics of an electrical aircraft, it will be appreciated that the described cooling system will be applicable to any heat-generating component in any location. For example, such a cooling system could be used in any electric vehicle or even at a stationary location housing heat-generating components.

Rather, these examples were provided so that this disclosure was thorough and complete and fully conveyed the scope of the possible examples to those skilled in the art.

Examples of the disclosure may be described according to the following aspects.
1. A thermal management system for a heat-generating component within an aircraft, the thermal management system comprising:
   a coolant line extending past the heat-generating component to enable coolant to flow past the heat-generating component during normal operation of the heat-generating component;
   a heat exchanger coupled to the coolant line to remove heat from the coolant line;
   a spray outlet disposed at the coolant line in proximity to the heat-generating component, the spray outlet configured to direct the coolant at the heat-generating component;
   a valve at the spray outlet, the valve being configured to control flow of the coolant from the cooling line through the spray outlet; and
   a smoke or fire detector disposed within the aircraft, the smoke or fire detector sending a signal to open the regulating valve when smoke or fire is detected.
2. The thermal management system of aspect 1, wherein the coolant includes SCO₂.
3. The thermal management system of aspect 1 or aspect 2, further comprising:
   a controller coupled to the smoke or fire detector and to the valve, the controller being configured to receive the signal from the smoke or fire detector and to actuate opening of the valve to spray the coolant through the spray outlet.
4. The thermal management system of aspect 3, wherein the spray outlet is one of a plurality of spray outlets disposed along the coolant line, each spray outlet having a corresponding valve, and the smoke or fire detector is one of a plurality of smoke and fire detectors disposed at different locations within the aircraft.
5. The thermal management system of aspect 4, wherein the controller is configured to activate one or more of the valves when one or more of the smoke or fire detectors closest to the one or more valves detects an occurrence of smoke or fire.
6. The thermal management system of any one of aspects 1-5, further comprising a reservoir of coolant, the reservoir having a size that is large enough to hold a sufficient amount of coolant for fire suppression.
7. The thermal management system of any of aspects 1-6, wherein the valve is a regulating valve.
8. The thermal management system of any one of aspects 1-7, wherein each spray outlet comprises a respective spray nozzle.
9. The thermal management system of any one of aspects 1-8, wherein the heat-generating component is one of a plurality of heat-generating components; and wherein the coolant line is one of a plurality of coolant lines routed past the heat-generating components; and wherein a plurality of the heat-generating components are in proximity to corresponding spray nozzles coupled to the coolant lines.
10. The thermal management system of any of aspects 1-9, wherein the heat-generating component includes a battery, a motor, or a power converter.
11. A method of fire suppression within an aircraft comprising:
   operating an onboard cooling system of the aircraft including circulating coolant through the onboard cooling system past one or more heat-generating components;
   detecting smoke or fire at a first of the one or more heat-generating components; and
   activating a spray outlet along the onboard cooling system to direct at least some of the circulating coolant towards the first heat-generating component.
12. The method of aspect 11, wherein circulating coolant through the onboard cooling system comprises circulating SCO₂ through the onboard cooling system.
13. The method of aspect 11 or aspect 12, wherein opening the spray outlet comprises opening a valve at the spray outlet.
14. The method of aspect 13, wherein opening the spray outlet comprises:
   receiving, at a controller, a sensing signal from a smoke or fire detector disposed at the first heat-generating component; and
   sending, from the controller, a control signal to the valve.
15. The method of any of aspects 11-14, further comprising:
   monitoring, via the processor coupled to the one or more level sensors, a level of coolant inside a coolant reservoir; and
   interrupting the activation of the spray outlet when the level of coolant inside the reservoir reaches a threshold level that corresponds to an amount of the coolant needed to continue operation of the aircraft.
16. A modular fire suppression system comprising:
   a pump;
   a reservoir configured to hold coolant, the coolant including SCO₂, the reservoir being coupled to a compressor;
   a plurality of coolant lines including hot coolant lines and cold coolant lines;
   a heat exchanger configured to be coupled to the plurality of coolant lines;
   the pump, the reservoir, the plurality of coolant lines, and the heat exchanger being housed in a housing; and
   the housing being configured to be coupled to an existing heat source.
17. The modular fire suppression system of aspect 16, wherein the existing heat source is one of:
   a battery system;
   power electronics; or
   a propulsive motor.
18. The modular fire suppression system of aspect 16 or aspect 17, wherein the existing heat source is one of:
   an aircraft battery system;
   an aircraft power electronics; or
   an aircraft propulsive motor.
19. The modular fire suppression system of any one of aspects 16-18, wherein the aircraft is an electric aircraft.
20. The modular fire suppression system of any one of aspects 16-19, wherein the coolant lines include outlets attached thereto from which the coolant can be released.
21. A fire suppressing system in an aircraft, the fire suppressing system comprising:
   a plurality of coolant lines, the coolant lines having SCO₂ circulating therein and comprising hot coolant lines and cold coolant lines;
   a heat exchanger separately coupled to the hot coolant lines and to the cold coolant lines;
   a plurality of spray outlets along the plurality of coolant lines; and
   a plurality of smoke or fire detectors disposed in a plurality of locations of the aircraft.
22. The system of fire suppression of aspect 21, further comprising:
   a plurality of regulating valves, each regulating valve being coupled to one of the spray outlets and configured to control flow of the SCO₂ through the plurality of spray outlets.
23. The system of fire suppression of aspect 21 or aspect 22, further comprising:
   a controller coupled to the plurality of smoke or fire detectors and to the plurality of regulating valves, the controller being configured to activate one or more of the regulating valves to spray SCO₂ through one or more of the spray outlets coupled to the one or more regulating valves.
24. The system of fire suppression of any one of aspects 21-23, wherein the controller is configured to activate the one or more regulating valves when one or more of the smoke or fire detectors closest to the one or more regulating valves detect an occurrence of smoke or fire.
25. The system of fire suppression of any one of aspects 21-24, further comprising:
   a reservoir of SCO₂, the reservoir having a size that is large enough to include a sufficient amount of SCO₂ for cooling and for fire suppression.
26. The system of fire suppression of any one of aspects 21-25, wherein a size of the reservoir is greater than 2 gallons.
27. The system of fire suppression of any one of aspects 21-26, wherein each of the spray outlets comprises a spray nozzle.
28. The system of fire suppression of any one of aspects 21-27, wherein the aircraft is an electric aircraft.
29. A fire suppressing system in an aircraft, the fire suppressing system comprising:
   a plurality of coolant lines, the coolant lines having SCO₂ circulating therein and comprising hot coolant lines and cold coolant lines;
   a heat exchanger coupled to the hot coolant lines and to the cold coolant lines;
   a plurality of spray outlets along the plurality of coolant lines;
   a plurality of smoke or fire detectors disposed in a plurality of locations of the aircraft;
   a processor operatively coupled to the plurality of smoke or fire detectors and to the plurality of spray outlets; and
   a memory coupled to the processor, the memory storing instructions that, when executed by the processor, perform a set of operations comprising:
   monitoring the plurality of smoke or fire detectors for an occurrence of at least one of elevated temperature, voltage, fire, and smoke;
   determining, via one or more of the smoke or fire detectors, whether a fire or smoke has occurred in the aircraft; and
   when the occurrence of fire or smoke is detected:
   identifying, via the processor, the one or more smoke or fire detectors that detected the occurrence of fire or smoke; and
   activating, via the processor, one or more of the plurality of spray outlets that are closest to the one or more of the smoke or fire detectors to spray SCO₂ on the detected smoke or fire.
30. The system of aspects 29, further comprising a reservoir of SCO₂, the reservoir comprising one or more SCO₂ level sensors, wherein the set of operations further comprises:
   monitoring, via the processor coupled to the one or more SCO₂ level sensors, a level of SCO₂ inside the reservoir; and
   interrupting the activation of the plurality of spray outlets when the level of SCO₂ inside the reservoir reaches a threshold level.
31. The system of aspects 29 or aspects 30, wherein the threshold level corresponds to an amount of SCO₂ that is necessary to continue operation of the aircraft.
32. The system of any one of aspects 29-31, wherein a size of the reservoir is greater than 2 gallons.
33. The system of any one of aspects 29-32, further comprising a plurality of regulating valves, each regulating valve being coupled to one of the plurality of spray outlets;
   wherein the set of operations comprises activating one or more of the plurality of spray outlets by controlling an operation of a regulating valve coupled to each of the one or more spray outlets.
34. The system of fire suppression of any one of aspects 29-33, wherein the aircraft is an electric aircraft.
35. A method of fire suppression in an aircraft, the method comprising:
   monitoring a plurality of fire or smoke detectors in the aircraft;
   determining whether a fire or smoke has occurred in the aircraft;
   identifying one or more of the smoke or fire detectors that detected the occurrence of fire or smoke; and
   when the occurrence of fire or smoke is detected:
   identifying one or more spray outlets that are closest to the one or more of the identified smoke or fire detectors; and
   activating the identified one or more spray outlets to spray SCO₂ on the detected smoke or fire.
36. The method of aspects 35, further comprising:
   monitoring a level of SCO₂ inside a reservoir feeding the one or more spray outlets; and
   interrupting the activation of the one or more spray outlets when the level of SCO₂ inside the reservoir reaches a threshold level.
37. The method of aspects 35 or aspects 36, wherein the threshold level corresponds to an amount of SCO₂ that is necessary to continue operation of the aircraft.
38. The method of any one of aspects 35-37, further comprising:
   activating the one or more spray outlets by controlling an operation of one or more regulating valves coupled to each of the one or more spray outlets.

Various modifications and alterations of this disclosure will become apparent to those skilled in the art without departing from the scope and spirit of this disclosure, and it should be understood that the inventive scope of this disclosure is not to be unduly limited to the illustrative examples set forth herein.

What is claimed is:

1. A thermal management system for a heat-generating component within an aircraft, the thermal management system comprising:
a coolant line extending past the heat-generating component to enable coolant to flow past the heat-generating component during normal operation of the heat-generating component;
a heat exchanger coupled to the coolant line to remove heat from the coolant line;
a spray outlet disposed at the coolant line in proximity to the heat-generating component, the spray outlet configured to direct the coolant at the heat-generating component;
a valve at the spray outlet, the valve being configured to control flow of the coolant from the cooling line through the spray outlet; and
a smoke or fire detector disposed within the aircraft, the smoke or fire detector sending a signal to open the regulating valve when smoke or fire is detected.

2. The thermal management system of claim 1, wherein the coolant includes SCO₂.

3. The thermal management system of claim 1, further comprising:
a controller coupled to the smoke or fire detector and to the valve, the controller being configured to receive the signal from the smoke or fire detector and to actuate opening of the valve to spray the coolant through the spray outlet.

4. The thermal management system of claim 3, wherein the spray outlet is one of a plurality of spray outlets disposed along the coolant line, each spray outlet having a corresponding valve, and the smoke or fire detector is one of a plurality of smoke and fire detectors disposed at different locations within the aircraft.

5. The thermal management system of claim 4, wherein the controller is configured to activate one or more of the valves when one or more of the smoke or fire detectors closest to the one or more valves detects an occurrence of smoke or fire.

6. The thermal management system of claim 1, further comprising a reservoir of coolant, the reservoir having a size that is large enough to hold a sufficient amount of coolant for fire suppression.

7. The thermal management system of claim 1, wherein the valve is a regulating valve.

8. The thermal management system of claim 1, wherein each spray outlet comprises a respective spray nozzle.

9. The thermal management system of claim 1, wherein the heat-generating component is one of a plurality of heat-generating components; and wherein the coolant line is one of a plurality of coolant lines routed past the heat-generating components; and wherein a plurality of the heat-generating components are in proximity to corresponding spray nozzles coupled to the coolant lines.

10. The thermal management system of claim 1, wherein the heat-generating component includes a battery, a motor, or a power converter.

11. A method of fire suppression within an aircraft comprising:
operating an onboard cooling system of the aircraft including circulating coolant through the onboard cooling system past one or more heat-generating components;
detecting smoke or fire at a first of the one or more heat-generating components; and
activating a spray outlet along the onboard cooling system to direct at least some of the circulating coolant towards the first heat-generating component.

12. The method of claim 11, wherein circulating coolant through the onboard cooling system comprises circulating SCO₂ through the onboard cooling system.

13. The method of claim 11, wherein opening the spray outlet comprises opening a valve at the spray outlet.

14. The method of claim 13, wherein opening the spray outlet comprises:
receiving, at a controller, a sensing signal from a smoke or fire detector disposed at the first heat-generating component; and
sending, from the controller, a control signal to the valve.

15. The method of claim 11, further comprising:
monitoring, via the processor coupled to the one or more level sensors, a level of coolant inside a coolant reservoir; and
interrupting the activation of the spray outlet when the level of coolant inside the reservoir reaches a threshold level that corresponds to an amount of the coolant needed to continue operation of the aircraft.

16. A modular fire suppression system comprising:
a pump;
a reservoir configured to hold coolant, the coolant including SCO₂, the reservoir being coupled to a compressor;
a plurality of coolant lines including hot coolant lines and cold coolant lines;
a heat exchanger configured to be coupled to the plurality of coolant lines;
the pump, the reservoir, the plurality of coolant lines, and the heat exchanger being housed in a housing; and
the housing being configured to be coupled to an existing heat source.

17. The modular fire suppression system of claim 16, wherein the existing heat source is one of:
a battery system;
power electronics; or
a propulsive motor.

18. The modular fire suppression system of claim 16, wherein the existing heat source is one of:
an aircraft battery system;
an aircraft power electronics; or
an aircraft propulsive motor.

19. The modular fire suppression system of claim 16, wherein the aircraft is an electric aircraft.

20. The modular fire suppression system of claim 16, wherein the coolant lines include outlets attached thereto from which the coolant can be released.
